(19) United States
(12) Patent Application Publication
(10) Pub. No.: US 2015/0127730 A1
(43) Pub. Date: May 7, 2015

(54) System and Method for Vehicle Alerts, Notifications and Messaging Communications

(71) Applicant: Shahar Sean Aviv, Hollywood, FL (US)

(72) Inventor: Shahar Sean Aviv, Hollywood, FL (US)

(21) Appl. No.: 14/080,869

(22) Filed: Nov. 15, 2013

Related U.S. Application Data
(60) Provisional application No. 61/900,537, filed on Nov. 6, 2013.

(51) Int. Cl. H04L 12/58; G06K 9/00

(52) U.S. Cl. CPC H04L 51/38; G06K 9/00624
USPC 709/204; 382/105

(57) ABSTRACT

A method, system, a computer program product, and mobile device application product that uses vehicle license plate information (license plate State, Number, and/or other information) and user location information (IP address, Mobile GPS, etc.) to send real-time alerts, notifications, or messages to individual users, organizations, external systems, and/or any other entity and/or third party systems.

### CROSS-REFERENCE TO RELATED APPLICATION

The present application claims priority benefit of U.S. Provisional Patent Application No. 61/900,537 filed Nov. 6, 2013, and entitled “System and Method for Vehicle Alerts, Notifications and Messaging Communications,” which is incorporated herein by reference.

### FIELD OF THE INVENTION

The present invention relates generally to communication systems and specifically to a system and method that enables communication using vehicle license plate information associated with individuals, organizations, and/or other entities. The system provides alerts, notifications, and messaging communication of information to FDA's, cellular phones, smartphones, tablets, tablet PC's, computers, servers, software systems, applications, databases, mobile devices, and any other devices, by utilizing vehicle license plate information.

### BACKGROUND OF THE INVENTION

There is a need for a method and/or system to alert, notify, and/or message individuals, organizations, companies and/or other entities, with information, for example, information pertaining to vehicle accidents, auto break-ins, driver behavior, and other events that require contacting individuals, organizations, companies and other entities (such as vehicle owners, insurance companies, warranty providers, logistics companies, and any other individual or entity) based on vehicle license plate information. There is a need for a communication method and system that receives license plate information (Country/State, License Plate Number, etc.) along with alert, notification, and message communication information, location, and/or images, which are then sent via any single or multiple methods of communication to the individuals or entities in real-time and/or scheduled event alerts, notifications, and messaging communication.

There are also safety concerns pertaining to vehicle parking, blocking, and any other safety reason that requires contacting vehicle owners, other individuals, and/or entities that are associated with vehicle license plate numbers and locations.

Therefore multiple reasons, purposes, and needs exist for enabling communication methods for alerts, notifications and messages to individuals, entities, and/or systems based on license plate information.

### SUMMARY OF THE INVENTION

The present invention satisfies the above described needs, and provides a method, system, a computer program product, and mobile device application product that uses vehicle license plate information (license plate State, Number, and/or other information) and user location information (IP address, Mobile GPS, etc.) to send real-time alerts, notifications, or messages to individual users, organizations, external systems, and/or any other entity and/or third party systems. The system receives vehicle license plate information, user location, optional images, and alert, notification, and/or messaging information, which are captured by the system, and are then sent via alerts, notifications, and messages to computers, phones, smartphones, tablets, tablet PCs, PDAs, or other mobile devices, external systems, servers, and/or any device via Electronic mail (Email), Mobile Short Message Service (SMS), Multimedia Messaging Service (MMS), Mobile Application Notifications, System Notifications, Application Programming Interface (API), and/or any third party systems.

The present system recognizes user location to add validation and details pertaining to the location and time of when the event was triggered and entered into the system.

In one aspect of the invention, users, in the vicinity of a vehicle where the owner, organization, or any other individual or entity that is associated with the vehicle is needed or is required to be contacted, can access the system via computer, phone, smartphone, tablet, computer, PDA, or any other device and enter the license plate information, and message detail and submit the alert, notification and/or message within the system to engage the contact(s) associated with the license plate number.

In another aspect of the invention, vehicle owners, other individuals, companies, organization, or any other entity that is associated with the license plate record in the system database, will receive the alert, notification, and/or message in real-time or as a scheduled task, to their mobile devices, smartphones, tablets, PCs, PDAs, servers, applications, and/or any other device via Email, SMS, MMS, Mobile App, API, and/or any third party system.

When a user sends an event notification via the system, personal information such as contact information is optional and may or may not be included as part of the alert, notification, and/or message in the system.

In another aspect of the invention, when a user sends a notification to the system, an image file such as a photo file may be uploaded into the system and included as part of the alert, notification, and/or message to the individuals or entities associated with the vehicle license plate.

In another aspect of the invention, License plate information (License plate number, State (and/or location/country) can be entered manually into the system or can be entered by utilizing Optical Character Recognition (OCR) software in combination with a device camera (PC camera, mobile device camera, or any other device with camera functionality) and/or image file/photo file (example. Jpeg, bmp. tif, etc.). The OCR software provides the ability to automatically capture and import the license plate image. The system will automatically convert the image into text and input that text into the license plate input fields within the system.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a diagram of an operating environment that supports the vehicle alert, notification, and messaging system of the present invention.

FIG. 2 is a flow chart showing the high level system function, according to an example embodied.

FIG. 3 is a diagram showing the alert, notification, and/or message process, according to an example embodied.

FIG. 4 is a flow chart that illustrates the system input, system functionality, and system output, according to an example embodied.

### DETAILED DESCRIPTION OF PREFERRED EMBODIMENTS

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Disclosed methods provide for a communication method and system using vehicle license plate numbers and message information to alert, notify, and/or message vehicle owners, other individuals, companies, organization, and/or any other entities. The system and method of the present invention receives vehicle license plate information, message details, location information, and/or image files and uses the license plate information (license plate state, number, or any other license plate information) to identify the individual, company, organization, and other entity associated with the vehicle, and the system then sends the notification in real-time to the receiving individual and/or entity via Email, SMS, MMS, Mobile App Notifications, System Notifications, API, and/or any third party systems.

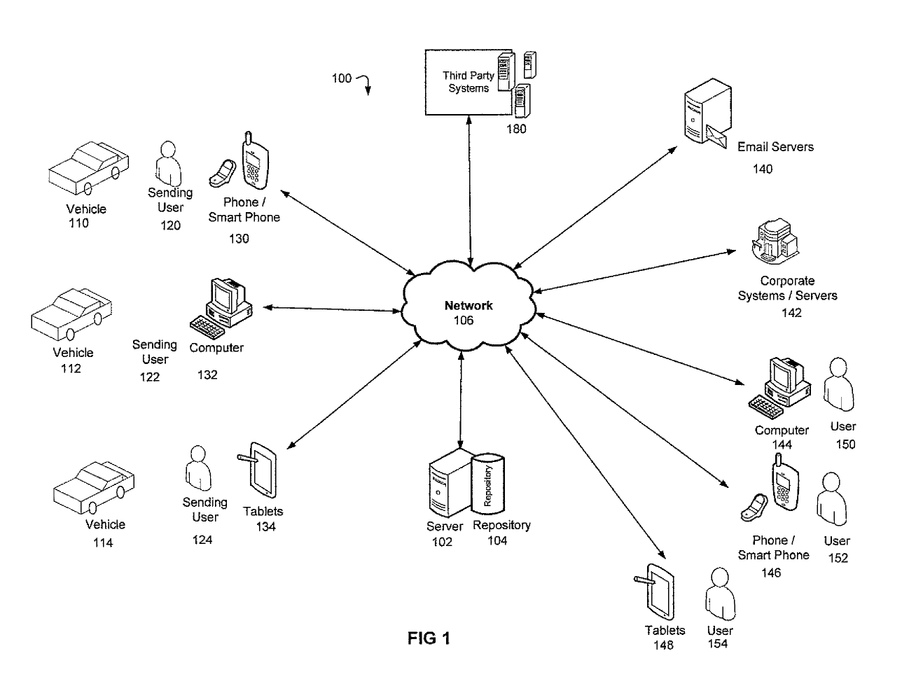

FIG. 1 is a diagram of an operating environment that supports the input of license plate numbers and message details into the vehicle alert, notification, and message system. The system sends messages to the individuals and/or entities associated with the license plate information according to an example embodied. The environment 100 may include multiple sending computers 130, 132, 134; multiple receiving computers and systems 140, 142, 144, 146, 148; multiple third party systems 180; and multiple servers 102; where each may comprise a computing device, including mobile computing devices such as cellular telephones, smartphones, tablet computers, or other computing devices such as a desktop computers, laptops, or servers for example. Communications network 106 may be a packet switched network, such as the Internet, or any local area network, wide area network, enterprise private network, cellular network, phone network, mobile communications network, or any combination of the above. The vehicles 110, 112, 114 represent the vehicles that the sending users 120, 122, 124 retrieve the license plate information from and can be any vehicle with a license plate number (i.e., cars, motorcycles, trucks, and any other motor vehicle with a license plate) and input the license plate information into the sending computers 130, 132, 134. The license plate information may include any combination of numbers, letters, and/or characters.

Environment 100 may be used with multiple third party systems 180 to integrate the present system server 102 and send communication alerts, notifications, and/or messages and send and receive system information via system connection such as an application programming interface (“API”) for example.

FIG. 1. further shows that server 102 includes a database or repository 104, which may be a relational and/or non-relational database comprising a Structured Query Language (“SQL”) database and/or noSQL, stored in a database server, such as Oracle, MySQL, MongoDB, or any database. Receiving computers 140, 142, 144, 146, 148 may also each include their own database. Third party systems 180 may also each include their own database. The repository 104 serves data from a database, which is a repository for data, used by server 102 and the user computers, during the course of operation of the system.

The database 104 may include a third party record for each user 150, 152, 154, any individual, organization, and/or entity, each receiving computer and system 140, 142, 144, 146, 148, any third party system 180, any vehicle license plate 110, 112, 114, any sending user, 120, 122, 124, and any sending computing device 130, 132, 134. The database 104 may further include any association between any of these entities.

FIG. 1 shows an embodiment of the present invention wherein networked computing devices 130, 132, 134 and computing devices 140, 142, 144, 146, 148, and any third party system 180 interact with server 102 and repository 104 over the network 106. Server 102 includes a software engine that delivers applications, data, program code and other information to networked computing devices 130, 132, 134 and computing devices 140, 142, 144, 146, 148, and any third party system 180. The software engine of server 102 may perform other processes. It should be noted that although FIG. 1 shows only nine networked computing devices 130, 132, 134 and computing devices 140, 142, 144, 146, 148, and third party system 180, the system of the present invention supports any number of networked computing devices connected via network 106.

Server 102 includes program logic comprising computer source code, scripting language code or interpreted language code that is compiled to produce executable file or computer instructions that perform various functions of the present invention. In another embodiment, the program logic of server 102 may be distributed among more than one of server 102, computers 130, 132, 134 and computing devices 140, 142, 144, 146, 148, and third party system 180, or any combination of the above.

Note that although server 102 is shown as a single and independent entity, in one embodiment of the present invention, the functions of server 102 may be integrated with another entity, such as one of the one or more of computing devices 130, 132, 134, 140, 142, 144, 146, 148, and 180. Further, server 102 and its functionality, according to a preferred embodiment of the present invention, can be realized in a centralized fashion in one computer system or in a distributed fashion wherein different elements are spread across several interconnected computer systems.

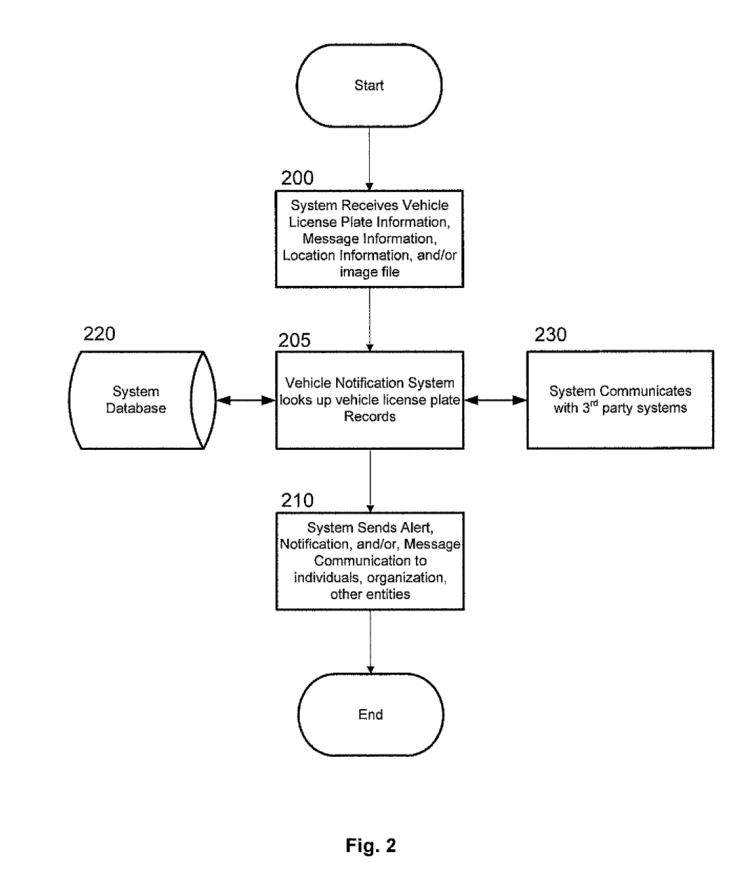

The process effectuated by the environment 100 of the present invention is as follows. The server 102 receives data from a sending computing device such as 130, 132, 134 pertaining to users such as 150, 152, 154 and/or computing devices such as 140, 142, 144, 146, 148, or any third party system such as 180. In FIGS. 2, 3, and 4 examples of user data that may be received, read, and/or recorded are provided. Based on the data that was received, read, and/or recorded, the server 102 associates a user and/or entity profile within the database to the received information.

Subsequently, the server 102 executes the alerting, notifications, and messaging functions upon receiving license plate information, message information, location information, and/or image files.

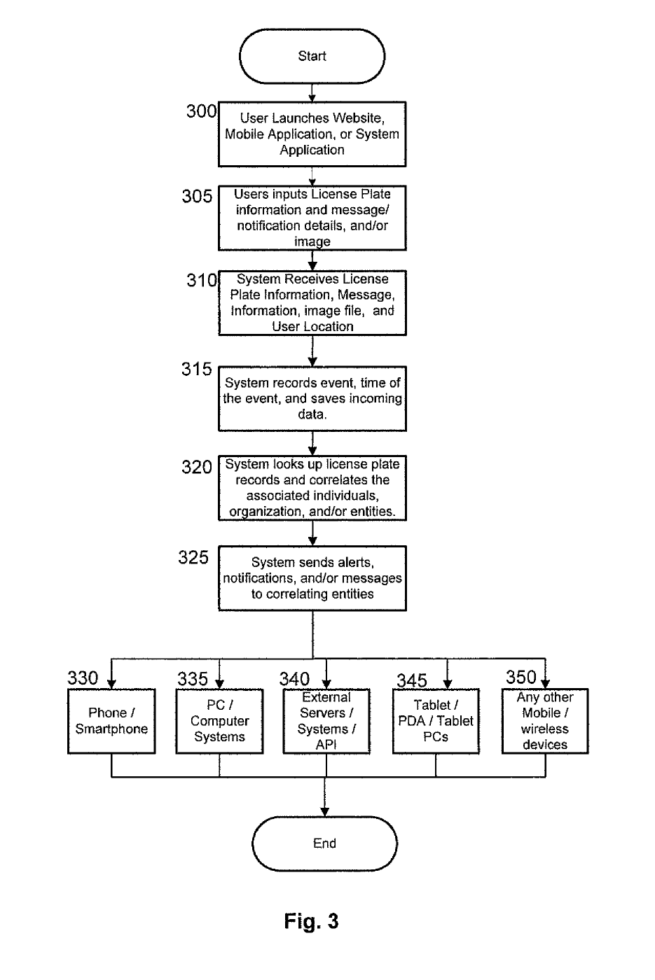

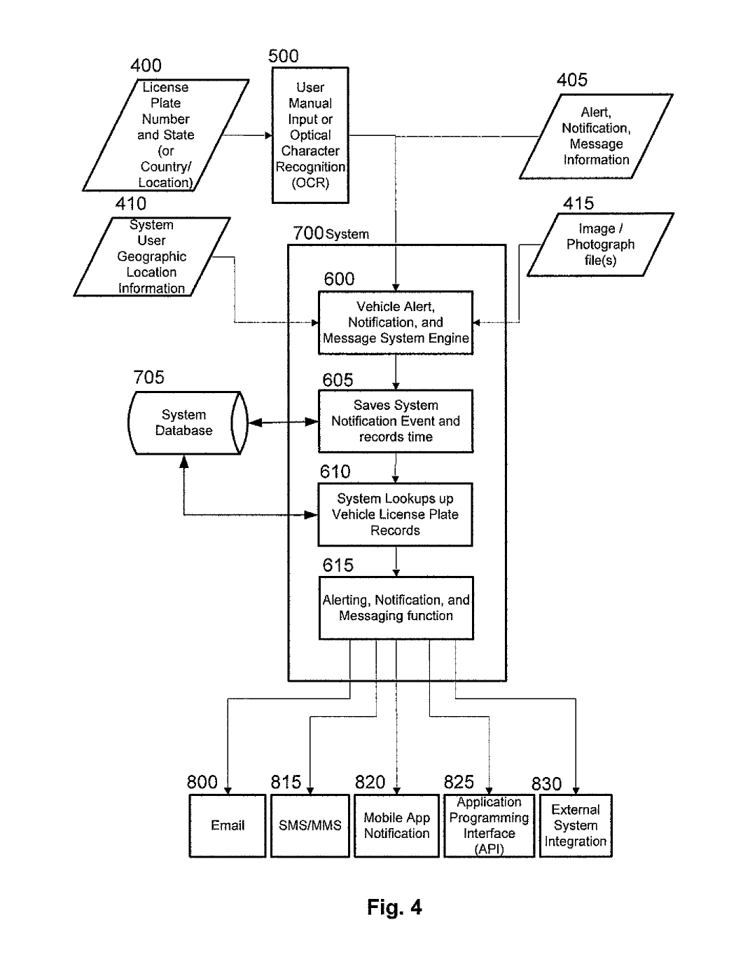

A high-level hierarchy of one embodiment of the vehicle alert, notification, and message communication system is illustrated in FIG. 2. The system and method receives vehicle license plate information, message information, user location information, and/or image file(s) in step 200. In step 205, the system then matches the license plate information with the records in the system database 220 which provides information on the entity associated with the vehicle and the alert, notification, and messaging methods and types to use for that entity. The system can also be integrated into third party systems 230 and can communicate alerts, notifications, and/or messages to the third party systems 230 as well as in step 210 sending alerts, notifications, and/or message communications to other individuals, organizations, and/or any other entity. The order of the steps in the embodiments illustrated in the various drawing figures, including FIGS. 3 and 4, may be varied depending upon the application and desired results or output.

To initiate the alert, notification, and message communication process, the sending users initially access the system application, website, and/or mobile application as depicted in FIG. 3. In step 300, the users would start by launching and/or accessing the system. Once the system is accessed, the user would then input the license plate information (license plate number, state, and/or any other license plate information), the message details (can be system preset messages, free text, and/or any other information for the user to input and/or select), and/or upload an image file to the system in step 305. The system receives the license plate information, message information, image file(s), and user location information in step 310. The system then saves the incoming data and records the request and time of event in step 315. The system then looks up the vehicle license plate information and identifies the individuals, organizations, and/or entities associated with that license plate in step in step 320. Once the record lookup is complete, the system sends the alerts, notifications, and/or messages in step 325 to devices and/or systems such as phones, smartphones, computer systems, PCs, Tablets, Tablet PCs, PDA, or any other device and/or system as shown in FIG. 3 for example 330, 335, 340, 345, and 350.

FIG. 4 illustrates the system input, system functionality, and system output. The system 700 receives information 400, 405, 410, and 415 which are the license plate number and state (or country/location and/or any other license plate information), the alert, notification, and message information (which can be a preset value, custom value, free text, and/or any other input), the user location information (GPS location, such as latitude/longitude coordinates, street address, city, state, country, zip code, etc.; IP-address based location; and/or any other method of attaining user location), and/or image and/or photo files. The license plate information can be manually entered into the system or by leveraging a camera on the end device (mobile phone, smartphone, pc, and/or any other device) and utilizing an optical character recognition system to automatically translate the image into text and automatically enter the license plate information into the system in step 500. The received information 400, 405, 410, and 415 is then processed by the system engine 600, which then saves the received information and records time of event 605 into the system database 705. The system then uses the license plate information to find the associated record in the database 705 which includes information on the specific alerting, notification, and messaging methods and communication details for that record. The system then conducts the alerting, notification, and/or messaging functions 615 to send the output alert, notification, and/or message via email, SMS, MMS, Mobile app notification, application programming interface (API), External system integration, and/or any other method of communication for example as shown in 800, 815, 820, 825, and 830.

The embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The invention is not limited to the specific details and representative embodiments shown and described herein. Accordingly, various modifications may be made without departing from the spirit or scope of the general inventive concept as defined and differentiated by the following claims.

What is claimed is:

1. A method, comprising:
creating a database in a storage medium, the database comprising records for entities associated with license plate data;
a network server receiving, from a first computing device, a communication including license plate data from a user reporting a vehicle condition and/or a vehicle related event;
the network server searching the database based on the received license plate data to locate a matching entity and/or matching record;
the network server sending a message to a second computing device associated with the matched entity, the message generated as a result of the communication received by the network server.

2. The method of claim 1, further comprising: obtaining the license plate data from an image file or device camera captured image.

3. The method of claim 2, further comprising: converting the image file to text by means of an optical character recognition program.

4. The method of claim 1, wherein the communication includes user location information.

5. The method of claim 4, wherein the user location information comprises GPS data.

6. The method of claim 4, wherein the user location information comprises an IP address.

7. The method of claim 1, wherein the message is sent by the network server to a third party system.

8. The method of claim 1, wherein the message is sent by the network server in real time.

9. The method of claim 1, further comprising: the network server sending multiple messages at a predetermined time.

10. The method of claim 1, wherein the license plate data is manually entered into the first computing device by the user reporting the vehicle condition.

11. The method of claim 1, wherein the license plate data is obtained as an image file by a device camera in the first computing device.

12. The method of claim 11, wherein the image file is converted to text by an optical character recognition (OCR) program.

13. The method of claim 1, wherein the communication includes an image file showing the condition of the vehicle.

14. The method of claim 1, wherein the communication is a preset message selected by the user.

15. The method of claim 1, wherein the communication is free text entered by the user.

16. The method of claim 1, wherein the network server stores the communication and records the time that the communication was received.

17. The method of claim 1, wherein the first and second computing devices are selected from the group consisting of cellular phones, smart phones, computer systems, personal computers (PCs), tablets, and personal digital assistants (PDAs).

18. The method of claim 1, wherein the network server sends the message via a communication mode selected from the group consisting of e-mail, SMS, MMS, mobile app notification, application programming interface (API) and external system integration.

19. A system, comprising:
a database containing entities associated with license plate data, the database stored in a storage medium;
a first computing device configured to send a communication including vehicle license plate data to a network server; and,
a network server configured to: receive the license plate data from the first computing device; search the database to find a matching entity; and send a message to a second computing device associated with the matched entity, the message being related to the communication.

20. The system of claim 19, wherein the matched entity is the owner of the vehicle and/or any individuals or entities associated with the vehicle.

21. The method of claim 19, wherein the communication includes user location information.

22. The method of claim 21, wherein the user location information comprises GPS data.

23. The method of claim 21, wherein the user location information comprises an IP address.

24. A system, comprising:
a database containing entities associated with license plate data, the database stored in a storage medium;
a first computing device configured to send a communication including license plate data from a vehicle to a network server; and,
a network server configured to: receive the license plate data from the first computing device; and search the database to find a matching entity;
means for sending a message to a second computing device associated with the matched entity, the message being generated as a result of the communication.

25. The system of claim 24, wherein the second computing device is associated with a third party system.
